(19) United States
(12) Patent Application Publication
(10) Pub. No.: US 2022/0253928 A1
(43) Pub. Date: Aug. 11, 2022

(54) ELECTRONIC CERTIFICATE SWAP METHOD AND SYSTEM

(71) Applicant: Memduh ASLAN, Ankara (TR)

(72) Inventor: Memduh ASLAN, Ankara (TR)

(73) Assignee: Memduh ASLAN, Ankara (TR)

(21) Appl. No.: 17/611,198

(22) PCT Filed: May 22, 2020
(86) PCT No.: PCT/TR2020/050445

§ 371 Date: Nov. 15, 2021

(30) Foreign Application Priority Data
May 22, 2019 (TR) 2019/07799

(51) Int. Cl. G06Q 30/08; G06Q 30/06; G06Q 20/38; G06Q 20/40

(52) U.S. Cl. CPC G06Q 30/08; G06Q 20/4014; G06Q 20/3821; G06Q 30/0613

(57) ABSTRACT

A method enabling an exchange of all kinds of goods, money and even services with each other and a system, wherein in the system the method is applied has been developed without touching an exchange feature of a money. By linking a physical world with electronic applications, the method and the system guarantees to be scalable, actionable any time of a day, simultaneous changeable, while guaranteeing an ownership transfer and a physical possession of an asset acquired at any time. A system infrastructure also enables new trade types, wholesale or retail secure e-commerce, and a development of new products for a financial system. Exchanging space or time benefits of goods of a same kind without intermediaries or to transfer a benefit unilaterally is also provided.

### CROSS REFERENCE TO THE RELATED APPLICATIONS

This application is the national stage entry of International Application No. PCT/TR2020/050445, filed on May 22, 2020, which is based upon and claims priority to Turkish Patent Application No. 2019/07799 filed on May 22, 2019, the entire contents of which are incorporated herein by reference.

### TECHNICAL FIELD

The development of technological communication and verification methods, the formation of the legal infrastructure of electronic transactions, electronic verification methods in procedural law, the acceptance of transactions as legal evidence in disputes between the parties, have directed the countries to digital transformation studies. On the one hand, while governments are maintaining the legal infrastructure and the public order in accordance with technological developments, and supporting the change and the transformation in these fields, on the other hand individual entrepreneurs are continues to develop technological products and services both in regulated areas and in areas that are not yet regulated with regulatory requests from governments. Although the banking system is a pioneer in digitalization, financial technological enterprises seeking non-bank solutions in payment and settlement systems are also taking their place in the market. There have been important developments in marketing with e-commerce approaches and e-marketing companies are rapidly becoming the strongest companies in the world. In addition to the digital transformation of products and services, licensed warehouses issue electronic product certificates in return for products delivered to them, thereby paving the way for the sales and marketing of these products in digital environment. Companies' partnership rights can be subjected to the trade as marketable value at capital markets, by stocking the stocks certificates to the stocks markets. Stocks market transactions have become one of the important indicators in determining the economic situation of the countries. Products traded on commodity exchanges can be subjected to the selling or buying trade with electronic product certificates, too. Legally, digital certificates can be issued—by real estate investment trusts for real estates, by Takasbank (clearance office of Turkey established as a bank) for gold, by asset rental companies for rent certificates, by insurance companies for pension funds, by banks for investment funds, by treasury for treasury bills, by central banks for state bonds- to transfer under the electronic environment and also to provide to transfer them between the participants in their own systems.

The common feature of regulated areas is that assets or rights represented by electronic certificates in terms of public order are kept in secure custody institutions defined by law and authorized by public authorities. On the other hand, crypto currencies that operated in blockchain systems can be exchanged electronically as manipulative values without any provision.

Even if assets or rights are suitable for digital transactions by their electronic certificates, each certificate issuer has their own systems and so we need the intermediary institutions to exchange the values in different systems, because these systems do not have the ability to communicate directly with each other. For example; the system of each bank operates independently from others. In order for the money in one bank to be transferred to another bank, intermediation of central bank of that currency is required. A person who wants to buy stocks in the stocks market cannot make transactions directly; he performs his transactions through the brokerage house. Even banks, while operating their resources, can realize their treasury transaction decisions over different systems, and need different intermediary institutions for completion of these operational transactions according to transaction types.

Simultaneous mutual transaction is not available between different markets. Using different technologies and/or software, local or national regulation differences in the area of application, variety of competent authorities responsible for regulation and supervision require using same software on the same infrastructure in order to be able to operate directly without brokerage, but this situation is almost impossible with the current technique. There is no infrastructure where assets or rights stored in secure custody institutions can be exchanged with each other without intermediaries, and the same market actors can trade among themselves without intermediaries.

Without the need to change existing systems of Secure custody institutions (banks, registration institutions, licensed warehouses, etc.) exchanging (swap) their electronic certificates of the deposited values with each other in a safe environment, will eliminate the necessity of the brokerage. On the other hand, while this new approach brings new methods to trade without using money, also brings new products, new methods and derivative instruments in the banking system that provide non-interest earning will be possible. With our project different market actors will be able to swap not only their products between same market actors but also different market products and between those market actors simultaneous without any brokerage.

### BACKGROUND

In the Turkish Code of Obligations (art. 282), swap (exchange of goods) contract is defined as first party's transferring the possession and ownership of one or more things to the second party as a counter obligation to the second party's transferring possession and ownership of one or more things to the first party. The provisions regarding the sales contract are also applied to the exchange of goods. Accordingly, each party is both the seller in terms of what it undertakes to give and the buyer in terms of what is undertaken to be given to it (TBK 283). The sales contract is defined as the contract where the seller transfers the ownership and property of the good to the buyer and the buyer undertakes a payment in return (TBK 207). Pursuant to Article 2 of the Value Added Tax Law, the swap contains two separate delivery obligation to subject taxation.

Although there are different patent applications regarding electronic exchange of goods or services, but these suggestions are only for the purpose of transportation of the property and do not include the transfer of possession that will provide actual use or control over the value of the transaction. Since these systems cannot guarantee the fulfilling of physical delivery obligation, the behavior of the person who pledges the transfer affects the system success, because the ownership of the chattel passes with delivery. Therefore, with our invention we focused on fulfilling the delivery obligation electronically between their owners of any value in the safe storage points within the common electronic system via putting their electronic certification into a same form. Our invention allows the exchange of certificates created based on different assets or rights in different systems. In our invention, there is no place or scale limit for application of the system. The need for money for the exchange of goods is significantly reduced when goods are exchanged without the problem of location and quantity.

One of the methods that enable the exchange of goods or services without using money is the barter. The barter company works like a financial company when implementing the barter system. Member of the barter company purchases its goods and service needs from the system and be in dept to the barter system for the price of the product purchased. The system allows the purchasing company a period of time to pay off its debt with selling its own product in the barter system. If the member can sell its own product within this period, it will be deducted from its debt, and must pay cash to the system for the part it cannot complete. In our invention, the system only offers the exchange infrastructure. In our system, unless a counter value is given that the seller can accept in return for the value transferred, the transaction does not take place. The system itself does not act as a financer in exchange transaction. There is no debtor creditor relationship in any transaction in our system. So, our invention is different from barter systems.

Clearing is the transactions carried out to end the debt, between two people who have a debtor and creditor relationship with each other and deduction and netting mean ending the right of receivables of the payee that has smaller right by deducting the same kind of the debts or credits for each other while the other party remains the creditor as much as the difference. Mutual obligations are deducted from each other and the difference is paid to the party in favor. In clearing/deduction systems, there are liabilities whose performance has not yet been completed as a result of more than one transaction for different reasons. Exchange and deduction of the same type of debts, usually monetary, are in question. Parties, who have to carry out transactions of the same type in their own system against each other, need to use reconciliation and clearing systems to reduce the number of transactions and the amount of financial transfer to be transferred to the other party and to clarify between total liability and total rights. In our invention, since all counter-obligations are completed simultaneously and there is no need for clearing or deduction, so, it differs from clearing.

Possibility of digital transferring of the ownership of dematerialized assets or values has been available for a long time. In areas where public authority is not available, the right to property is closely linked to possession. Those who have the power to hold the goods and protect themselves against others are considered to be the owners of the goods they hold. Under the law of the jungle, powerful person is the owner of everything. One of the most important indicators of the legal order is the right to property and the protection of this right. Allowing the assets and rights under the disposal of individuals to be exchanged only with their consent, whether in a physical environment or dematerialized, is one of the protected rights by the legal order.

The order of law for the transfer of property right has introduced different legal rules according to the type of property or rights. While the legal order may subject the transfer of real estates and vehicles to formal form and registration, it is often considered sufficient to hand over the transfer of ownership of chattels. Possession is the possession of a property and is often an important indicator of property for chattels. Therefore, the transferring the property right of the chattel with delivery makes it difficult to determine how the person holding the possession of the chattel. Similarly, the transfer of the bearer shares of the companies can be made upon delivery.

Safe storage points have started to be defined in legal order to prevent the change of hands of properties and rights that the ownership of them changed with delivery and possession is the indicator of their property right, against the will of the owner. On the other hand, there are physical obstacles in the transfer of chattels that has high volume. Their dematerialization also emerges as an improved method against physical difficulties. Banks are the most important of safe storage points for money. The money delivered to the banks are dematerialized by the bank, allowing them to be transferred digitally, and different security measures are taken to ensure that this transfer is accomplished by the will of the owner. Similarly, agricultural products that hold volume delivered to licensed warehouses are tied to the product certificate, making it easier to deliver them with the product bill, while arranging these vouchers digitally, making the transfer legally possible.

By delivering gold to the Clearing Bank in Turkey and dematerializing in the same way, buying and selling gold as dematerialized it has also become possible. The common feature of all these systems, while give availability to change the property rights on records without the physical delivery of any property or right, also when desire, new registered holders can physically receive the assets or rights (physical document representing the right) by deduction from records. There is no obstacle to be changing of the assets or rights whose ownership can be changed electronically by registering them within the same system. It is possible to change the national currency in the bank with the foreign currency in the same bank without leaving the system. In practice, this transaction can only be done between the bank and the customer, but two customers cannot simultaneously swap the two different values in the same bank system. Systems are generally based on transfer rather than mutual exchange. Changing the mutual assets of the account holders' results in the completion of the mutual acts in the contract made outside the system with different transactions. The operations of the contract emerge as a combination of two different remittances that take place at different times.

However, a solution for the mutual exchange of the national currency in one bank and the foreign currency in another bank has not been developed. The basic requirement in the solutions found is that the values to be changed are at the same safe storage point, and in the exchange process, more than one account is required for the operation at the same safe storage point. In the banking system, the national central bank is required for the EFT transaction to be carried out for national money transfers for accounts located in two different banks under normal conditions, for the SWIFT transaction for foreign currency transfer, the correspondent banks authorized to operate in the country where the foreign currency belongs and the relevant central bank are required.

In swap transactions of different currencies between banks, operator banks being in different time zones, having different working hours/trading hours, brings the risk of default due to second performance being late. To solve this problem, there is the Continuous Linked Settlement System implemented in CLS Bank International in order to change different currencies simultaneously among customers. In this system, if banks open accounts at CLS Bank, they will have the opportunity to make simultaneous exchanges between their accounts in this bank. Currently, it is possible to trade simultaneously in 17 different currencies.

Transactions between people who have accounts in two different banks are made through the EFT system of the central bank. However, this system can be used at certain times of the day. There is also a time problem in transactions between two different bank accounts. It is possible to make a transfer at any time of the day as it does not make any difference in the national accounts at the central bank within the same bank. EFT, on the other hand, requires the central bank to keep this system open, as banks differ in their national currency accounts. To solve this kind of time limit problems of transactions, an application has been developed in Turkey named nobetci (means on duty in Turkish) transfer. The person performing this application uses its own accounts in banks as a balancer a way that does not change bank's' obligations at central bank. In exchange for the transfer made to its own account in one bank, the company transfers it from its own account to the buyer account in the other bank. In this system, users use this application as a tool to bypass the EFT transaction. The transaction is limited to the account balance of the intermediary institution can use as a balancer. When the EFT system is opened, this type of solution will need to utilize EFT transactions to balance the need for account balances in banks for the sustainability of these transactions.

On the other hand, because of the transferring of different assets and rights in electronic environment in different systems, performing transactions sequentially rather than simultaneously, being a lot of the number of transactions in a certain period of time, instead of actually perform more than one transaction for each action, with orderly (mostly daily and sole) transactions it is attempted to alleviate the actual transaction load, by netting off the rights and obligations of secure storage points by clearing/deduction method. Although clearing systems reduce actual transactions, they cannot eliminate actual transaction obligation. Since different values are traded in different systems, it is also important to follow net liabilities related to all assets, as clearing, deduction and netting operations have to be carried out at different points. In order to meet this need, institutions such as MarkitSERV, tradeServ, DTCC (The Depository Trust & Clearing Corporation) mostly try to perform clearing and netting transactions of transactions in different systems related to similar assets or rights from a single point. Since the obligation remaining as a result of netting operations must actually be fulfilled, a change in the amount/amount of assets or rights stored in safe storage points is inevitable.

Changing location benefit is done in actual practice. For example, banks, which have to keep a certain amount of banknotes or coins per day, should send money to their branches if they fall below a certain amount, and if they exceed a certain amount, they should receive this money to their headquarters. It is challenging to perform this operation for branches located in different cities. This problem is tried to be solved by using the money carrier companies which carries out money transfers of more than one bank. The needs or surpluses of more than one bank in the same region are clarified by clearing and offsetting in the region and the need for money transportation is tried to be reduced. In our invention, the location benefit of a value is directly changed between the two parties without using any intermediary institution. In current applications to change the location benefit of a value, all parties must need requirements to change their owned values' location benefits, but, in our invention, even if only one of the parties needs to change the local benefit for a value, the system can be operated. Our invention also has effects that increase efficiency, including reduced logistics costs and saving time by eliminating the time spent on the road.

Due to the fact that Swift transactions are carried out with multiple intermediaries in the financial sector, the transaction realization stages and the transaction costs received cannot be tracked easily. In order to eliminate this problem, by being a membership of the GPI (Global Payments Innovation) system, banks share their data here and system informs other members to track SWIFT applications. However, since tracking will be limited only to the member banks, this system try to develop the measures to encourage membership.

The problems of interchange of different assets with each other, having to use the vehicle, transaction time, the transaction limit in the known techniques, the simultaneous transaction, have not been fully resolved. These problems are solved with our invention. It is not necessary to include all safe storage point in the system for the system to work. The system is scalable and all transactions within the system are traceable. The system can change the location or time benefit even in a single safe storage point type.

With our invention, simultaneously exchange of any dematerialized asset or right with each other can be realized without any time or transaction limit, intermediate institution and safe storage point transactions. The system also enables a one-sided transfer in the classical sense, too. In this respect, the system does not prevent the fulfillment of mutual actions at different times or environments, and also enables to use classical solutions.

With establishing smart contracts our invention has been fixed the problem of the asset or right holders' need any intermediary in the system to establish the contract and to complete different transactions for changing different values when mutual wills of the parties match. Simultaneous transfer of property in our invention removes the need for clearing, deduction or netting between safe storage points, as it does not cause any change in the amount of values stored in the safe storage point.

Since all exchanges are made in the same system, it is not limited to any time for asset or rights holder property transfer. The asset or right at each safe storage point, which is a system member whose property right is protected, can be subject to change simultaneously regardless of where it is located in the world. This also eliminates the problem of location and time limits of transactions. Our invention brings a novelty that has never been before, by allowing not only different assets or rights but also goods at different points to be exchanged for different time conditions, allowing the transfer of ownership from one place to another without any physical transportation. For example, since our invention allows the exchange of a certain amount of wheat in city A, with a certain amount of wheat or a different product in the city B, it also reduces the transportation costs by reducing the physical transportation need of the asset. Since the system allows for change with the time-dependent benefits of the same kind of assets or rights, exchange of time-dependent rights is also possible. For example, by replacing the electronic money with the Certified Commercial Electronic Money that has not expired, the return into cash can be accelerated.

In our invention, the system is used as a tool, not an intermediate in transactions. The system does not have any assets or rights to balance the accounts at the safe storage points. Since there is no actual change in assets or rights, there is no problem of quantity or volume in transactions.

In order for the assets or rights holders to make transactions among themselves in the system, the obligation to have separated accounts at the secure storage points where the assets or rights to be changed are also eliminated.

Since the system provides a new infrastructure, it is also suitable for the development of new product and finance models thanks to this infrastructure. For example, since banks will create interest-free income opportunities by creating funds or derivative instruments consisting of different products in the system, a bank can also reduces the cost of funding in the resources it will collect without investing any new products.

In borrowing transactions, with the electronic pledge mechanism, the contingent conditions between the parties realized automatically when the condition is fulfilled and prevent the occurrence of dispute.

### SUMMARY

The purpose of the invention is to create a new method and a new system for implementation of this method for all kinds of material/intangible assets that are taken under protection at secure storage points and the right of ownership is attached to an electronic certificate to ensure the simultaneous exchange (swap) of registration or financial rights with each other and transfer of ownership, to return of securities/rights documents partially or wholly in physical environment when requested by the owner, to allow conditions where different or identical market actors can directly trade with each other, to establish a smart contract and concluding its operations simultaneously, without any time constraints, to protect the right to property electronically, to develop new types of business transactions.

### BRIEF DESCRIPTION OF THE DRAWINGS

In order for the present invention to be understood and its advantages in conjunction with additional elements, it should be evaluated together with the figures described below.

The exchange between 3 assets is shown for easy understanding of the figure; there is no unit limitation in the system.

FIG. 1: This is a general flow chart showing the working variations of the system subject to the invention.

FIG. 2: It is a private supply or demand flow chart for certain persons for the exchange of certificates defined in the system.

FIG. 3: Public supply or demand flow chart for the exchange of certificates defined in the system.

FIG. 4: The Bargains flow chart in the tramp of certificates defined in the system.

FIG. 5: It is the flow diagram that provides the displacement effect of the goods owned by the swap of the electronic certificate of the same values in different locations.

FIG. 6: Flow chart of electronic certificates, the request of which is limited for a certain period from secure storage points that makes the time limit ineffective by swapping with limitless electronic certificates.

FIG. 7: Flow chart of the pledge mechanism that protects the property right regarding the borrowed electronic certificates.

### REFERENCE NUMBERS

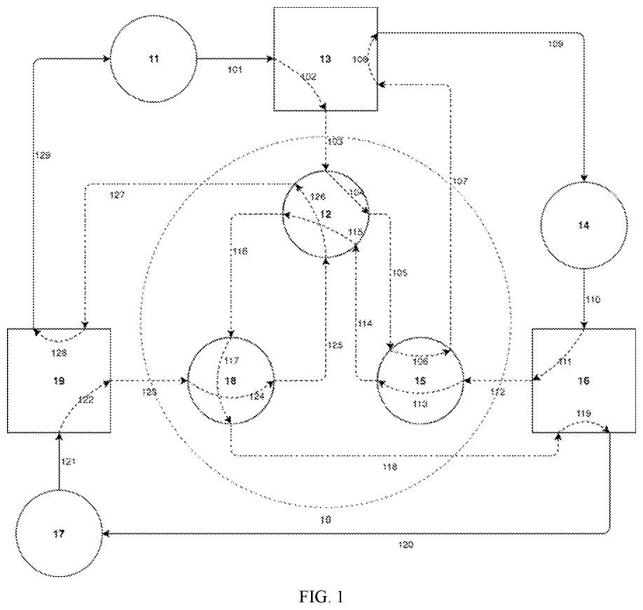

FIG. 1—Flow Chart of the Electronic Certificate Swap System

diagrams
10 The Electronic Certificate Swap System-system
11 agricultural product
12 product certificate issued for agricultural product
13 licensed warehouse that stores agricultural product and issues an electronic product certificate
14 stocks
15 electronic stocks certificate issued for stocks
16 the registrar that stores the stocks and issues an electronic stocks certificate
17 money
18 electronic money certificate issued for money kept in the fund account
19 electronic money institution that issues an electronic money certificate against the money deposited in the fund account

Transactions
101 physical process: delivery of the agricultural product of the owner to the licensed warehouse
102 issuance process: issuance of product certificate for the agricultural product received by the licensed warehouse
103 transfer process: transferring the electronic product certificate to the owner's wallet in the system
104 application of smart contract: proposal/acceptance of swapping product certificate with stocks certificate—corresponding to transaction 113
105 operational transaction: swapping product certificate with stocks certificate—simultaneously with transaction 114
106 exit from the system: request to actually withdraw the agricultural product represented by the product certificate from the licensed warehouse
107 transfer process: return of the electronic product certificate to the licensed warehouse wallet
108 repeal process: the licensed warehouse repeals the electronic product certificate and withdraws it from the circulation
109 physical process: delivery of the agricultural product to the recent owner of the electronic product certificate by the licensed warehouse
110 physical transaction: delivery of the stocks to the registry
111 issuance process: registrar's issuance of electronic share certificate for the stocks
112 transfer process: transferring the electronic stocks certificate to the owner's wallet in the system
113 application of smart contract: proposal/acceptance of swapping electronic stocks certificate with electronic product certificate—corresponding to transaction 104
114 operational transaction: swapping electronic stocks certificate with electronic product certificate—simultaneously with 105
115 application of smart contract: proposal/acceptance of swapping electronic stocks certificate with electronic money certificate—corresponding to transaction 124
116 operational transaction: swapping electronic stocks with certificate electronic money certificate—simultaneously with 125
117 exiting from the system: request to deliver the stocks represented by the electronic stocks certificate from the registrar
118 transfer transaction: return of the electronic stocks certificate to the registrar's wallet
119 repeal process: the registrar repeals the electronic stocks certificate and withdraws it from the circulation
120 physical transaction: submission of the stocks to the recent certificate owner by the registrar
121 deposit process: deposit of money into the fund account of the electronic money institution
122 issuance process: issuance of electronic money certificate for the money deposited in the fund account of the electronic money institution
123 transfer process: transfer of the electronic money certificate to the owner's wallet in the system
124 application of smart contract: proposal/acceptance of swapping electronic money certificate with electronic stocks certificate—corresponding to transaction 115
125 operational transaction: swapping of electronic money certificate with electronic stocks certificate—simultaneously with 116
126 exit from the system: request for reimbursement of the money represented by the electronic money certificate from the electronic money institution
127 transfer process: transfer of the electronic money certificate to the electronic money institution's wallet
128 repeal process: the electronic money institution repeals the electronic money certificate and withdraws it from the circulation
129 physical transaction: electronic money issuing institution's refunding the money

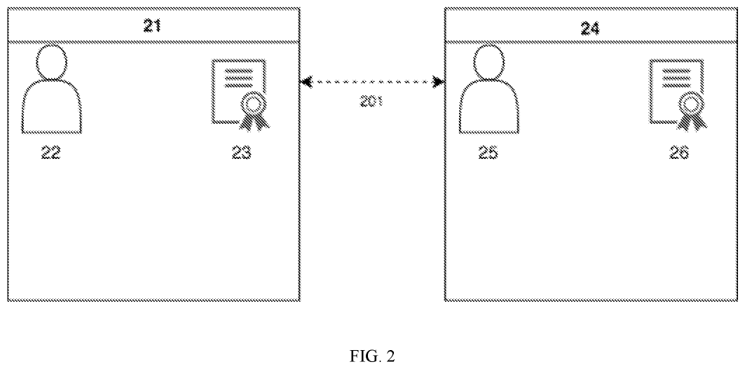

FIG. 2—Flow Chart of the Private Supply/Demand

Diagrams
21 first system user wallet
22 first identification number of the wallet holder
23 first electronic certificate in the wallet
24 second system user wallet
25 second identification number of the wallet holder
26 second electronic certificate in the wallet

Transactions
201 swap

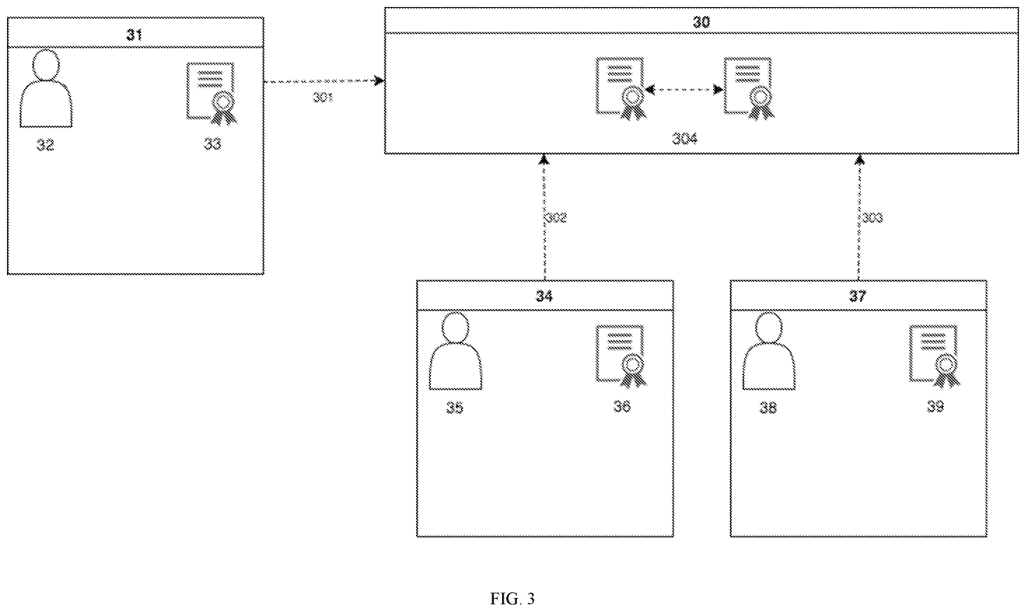

FIG. 3—Flow Chart of the Public Supply/Demand

Diagrams
30 bid board
31 first system user wallet
32 first identification number of the wallet holder
33 first electronic certificate in the wallet
34 second system user wallet
35 second identification number of the wallet holder
36 second electronic certificate in the wallet
37 third system user wallet
38 third identification number of the wallet holder
39 third electronic certificate in the wallet

Transactions
301 the announcement of the certificate in the first wallet on the bid board
302 counter bid or acceptance of the certificate in the second wallet for swap
303 counter bid or acceptance of the certificate in the third wallet for swap
304 swap

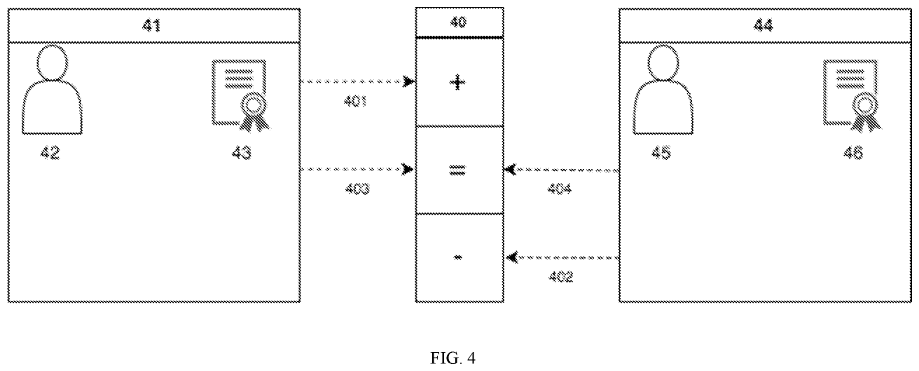

FIG. 4—Flow Chart of the Bargains

Diagrams
40 alignment board
41 first system user wallet
42 first identification number of the wallet holder
43 first electronic certificate in the wallet
44 second system user wallet
45 second identification number of the wallet holder
46 second electronic certificate in the wallet

Transactions
401 the bid with the certificate in the first wallet
402 counter lower bid with the certificate in the second wallet from expected swap value
403 the new bid with the certificate in the first wallet lower than the bid at transaction
401 and higher than the bid at transaction 402 for the swap
404 acceptance of the bid at transaction 403
405 swap

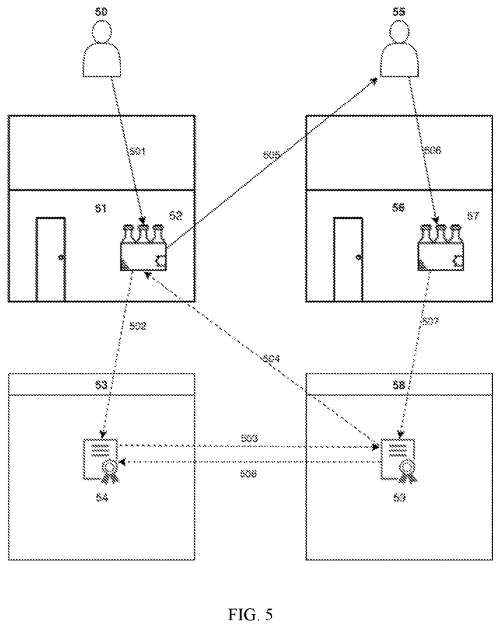

FIG. 5—Flow Chart of Asset Displacement

Diagrams
50 first system user
51 safe storage point in city a
52 product X placed at the safe storage point in city A
53 first system user wallet
54 electronic certificate of the product X in city A
55 second system user
56 safe storage point in city B
57 product X placed in a safe storage point in city B
58 second system user wallet
59 electronic certificate of product X in city B

Transactions
501 delivery of product X to the safe storage point in city A by the first system user
502 electronic certificate issuance about the product X in city A
503 swapping electronic certificate of product X in city A with the electronic certificate of product X in city B
504 physical delivery request of product in city A
505 physical delivery of the products in city A to the second system user
506 delivery of product X to the safe storage point in city B by the second system user
507 electronic certificate issuance about product X in city B
508 swapping electronic certificate of product X in city B with the electronic certificate of product X in city A

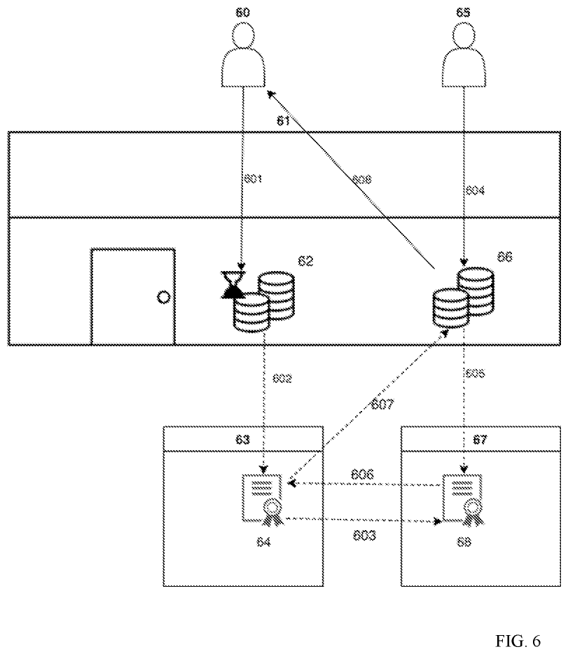

FIG. 6—Flow Chart of Asset's Time Benefit Change

Diagrams
60 first system user
61 financial institution
62 deposited money for certain term
63 first system user wallet
64 electronic term deposit certificate
65 second system user
66 money
67 second system user wallet
68 electronic money certificate

Transactions
601 first system user's depositing his money to the financial institution for a certain term
602 issue of electronic term deposit certificate
603 swapping electronic term deposit certificate with electronic money certificate
604 second system user's depositing money at the financial institution
605 electronic money certificate issuance
606 swapping electronic money certificate with electronic term deposit certificate
607 requesting the money from the financial institution
608 refunding the money to first system user

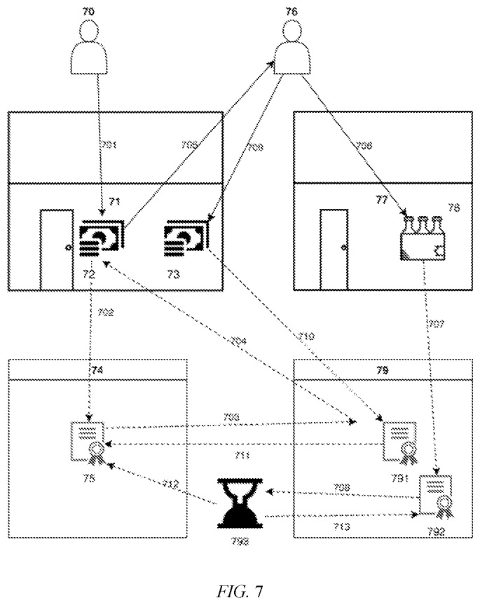

FIG. 7—Flow Chart of the Swap of Pledge

Diagrams
70 first system user
71 first safe storage point
72 asset P, delivered to first safe storage point by first system user
73 asset P, delivered to first safe storage point by second system user
74 first system user wallet
75 electronic asset certificate
76 second system user
77 second safe storage point
78 product X, delivered to second safe storage point by second system user
79 second system user wallet
791 electronic asset certificate
792 electronic product certificate
793 pledge mechanism

Transactions
701 delivering of asset P to the first secure storage point by the first system user
702 issuance of the electronic asset certificate of asset P and transferring it to the first system user wallet by the first secure storage point
703 first system user transfer of the electronic asset certificate to the second system user's wallet the against the pledging of electronic product certificate
704 transfer of electronic asset certificate to the first safe storage point by the second system user
705 delivery of asset P to the second system user by the first safe storage point
706 delivery of product X to second safe storage point by the second system user
707 issuance of the electronic product certificate of product X and transferring it to the second system user wallet by the second secure storage point
708 second system user's allowing pledge of the electronic product certificate against the electronic asset certificate transferred to its wallet and pledging of the electronic product and temporarily limitation of possession rights of second system user on electronic product certificate
709 delivery of asset P to first safe storage point by the second system user
710 issuance of the electronic asset certificate of asset P and transferring it to the second system user wallet by the first secure storage point
711 transfer of borrowed electronic asset certificate to the first system user by the second system user
712 if the borrowed electronic asset certificate is not returned to the first system user at the specified time, pledged electronic product certificate is swapped with it instead of being the return to the second system user
713 in case the borrowed electronic asset certificate is returned to the first system user before the specified time, the pledge on the electronic product certificate is removed and possession rights of the second system user is released

### DETAILED DESCRIPTION OF THE EMBODIMENTS

The Electronic Certificate Swap System is a system that provides electronically swapping of the dematerialized asset by keeping under protection at the safe storage points without any time limit. And it also provides to swap of the ownership (partially or completely) of these records at the specific secure storage point with other electronic certificates defined in the system regardless of whether other system users have accounts at that secure storage point. In FIG. 1, we show the registrar that issues the electronic certificate of the stocks by securing the stocks to represent the capital market transactions, licensed warehouse that issues electronic product certificates by securing agricultural products to represent product market transactions and electronic money institution that issues electronic money certificates by depositing the money at a bank to represent the financial market. Any electronic certificate issued in areas with legal regulations and regulated by legally defined secure storage points can be used in the system. Electronic certificates issued by the custodial organizations that work on the unregulated or incomplete regulated areas, can be included in the system. All kinds of values, such as crypto currencies, electronic bills or electronic bonds that can be certified in the system, can also be subject to swap. Three products and three certification bodies were considered sufficient to explain the invention.

Assets or rights (11, 14, and 17) are delivered by their owners to the secure storage points (13, 16, and 19) where these values will be kept.

The licensed warehouse (13) creates a record for the agricultural product delivered to it and issues an electronic product certificate (12) and identifies the record to the owner's wallet in the system. In this way, the electronic product certificate can be transferred by the owner to other system users within the system rules.

The registrar (16) creates a record for the stocks delivered to it by the owner and issues an electronic stocks certificate (15) and identifies the record to the owner's wallet in the system. In this way, electronic stocks certificate can be transferred by the owner to other system users within the system rules.

The electronic money institution (19) creates a record for the money deposited in the fund account and issues an electronic money certificate (18) and identifies the record to owner's wallet in the system. In this way, the electronic money certificate can be transferred by the owner to other system users within the system rules.

Those who have electronic certificates defined in their wallets in the system are required to submit an offer to the other party in order to transfer these electronic certificates and to accept the offer in return for the electronic certificate required by the submitter (104:113 and 115:124). The system carries out the certificate exchange requests approved by both parties at the same time (105:114 and 116:125).

The person who receives the electronic product certificate in exchange for the electronic stocks certificate may continue to use the electronic product certificate in the system, or he can exit the system by requesting the agricultural product physically from the licensed warehouse (106) which a secure storage point. When the electronic product certificate in the wallet is transferred to the licensed warehouse wallet (107), the licensed warehouse cancels the electronic product certificate and closes the registration of the agricultural product (108) and delivers the agricultural product physically to the electronic product certificate's recent owner (109).

The new owner who receives the electronic stocks certificate in exchange for the electronic product certificate may continue to use the electronic stocks certificate in the system, or he can exit the system by requesting the stocks physically from the registrar. Before the electronic stocks certificate is exchanged with the electronic money certificate, the owners should also ensure mutual offer and acceptance (115:124) compatibility. As soon as proposals match with acceptances for this swap, the transfers of electronic stocks certificate and electronic money certificate for swapping occur simultaneously (116:125).

The system user who changed his electronic stocks certificate with an electronic money certificate, may continue to use the electronic money certificate in the system, or may request that the money refund from the electronic money institution (126) to exit the system. When the electronic money certificate is transferred to the electronic money issuer wallet (127), the electronic money issuer cancels the electronic money certificate and closes its registration and pays the money back to the bank account of the recent certificate holder (129).

The person who receives the electronic stocks certificate in exchange for the electronic money certificate may continue to use the electronic stocks certificate, or request the stocks from the registrar (117) to exit the system. When the electronic stocks certificate in the wallet is transferred to the registrar wallet (118), the registrar cancels the electronic stocks certificate (119) and closes the registration of the stocks and delivers the stocks to the recent certificate holder (120). While the transaction is completed with the mutual performance of two people in the physical swap, more than one electronic certificate swap operation can take place until the physical swap is completed with the system. As it can be seen in FIG. 1, although there is no swap operation between the stocks owner and the money owner, the stocks have reached to the money owner. When owner want to convert the agricultural products into money, but if money holder prefers stocks to product, first he swap products with the stocks because of money holder's willing on stocks and then after being stocks holder he swap stocks with the money to reach the main purpose. Without affecting the purchase function of money but also without using money, system also eliminates to need to be mutual ownership of necessary assets, while swapping assets to meet the necessities.

For swapping, two asset and owners of these assets must meet and their intentions must reach each other. In FIG. 2 and FIG. 3, the methods of coming together of the swap parties are given. In FIG. 2, shown the direct interaction when parties know each other. In order to sending supply or demand order in the system for a system user's (22) swapping an electronic certificate (23) in its wallet (21) with another electronic certificate (26) in another system user's (25) wallet (24) first system user (22) has to known the identification number of second system user (25). This order can only be seen by two these system users and the offer can only be accepted by the second user. As soon as the second user accepts the proposal, swap transaction realize automatically (201). In FIG. 3, parties who are not known of each other can interact via the supply/demand board. When a system user (32) wants to swap the electronic certificate (33) in his wallet (31), but does not know the any appropriate person to whom he can send supply/demand order, he can sends his offer to the supply/demand board (301) which other system users (35 and 38) can see. Other users can see the orders from the supply/demand board and when they accept any of them (302 and 303), swapping (304) is completed simultaneously. When more than one user wants to send acceptance to the order in the supply/demand board (30), since the first acceptance will triggered swap, the remaining acceptances cannot be able to send to the board. Supply/demand orders owners can withdraw their offers before they are accepted.

Both private and public supply/demand offers do not have to be accepted with the conditions in the offers. Other system user can make counter offers instead of acceptance. FIG. 4 shows the agreement with bargains.

When a system user (42) creates supply/demand offer (401) to swap the electronic certificate (43) in his wallet (41), the other system user (45) may send counter offer a lesser amount from his certificate (40) his wallet (44). Since the offer and acceptance do not match, the swap process will not take place. However, the first system user (42) may renew his offer at a lower level than the previous one (403), the other party (45) may submit a new counter offer, or unless their final offer is accepted in any stage, the parties may change their offers by lowering or rising as they want. When a certain period is not specified, the swap (405) occurs as soon as reconciliation (404) is achieved. If a certain period is determined, the conditions of the swap are determined according to the situation at the time of expiration.

A system user can transfer the benefits of the electronic certificates in economy ecosystem that he is in to other system user with swapping. FIG. 5 indicates location efficiency exchange and FIG. 6 indicates the time efficiency exchange.

In FIG. 5, there are system users in two different places with the same type of assets. While it does not matter where the asset's being for one of the users of the system, for other user, there may be a superior benefit in assets being in that place. First system user (50) delivers (501) his products (52) to the warehouse (51) in city A, the electronic product certificate (54) is issued (502) and transferred to the first system user's (50) wallet (53). Second system user (55) delivers his products (57) to the warehouse (56) in city B (506), the electronic product certificate (59) is issued (507) and transferred to the second system user's (55) wallet (58). First system user (50) and the second system user (55) swap (503:508) electronic product certificates (54:59). Second system user (55) physically requests (504) the products (52) in city A (504) with the electronic product certificate (54) transferred to her wallet (58) and receives these products in city A (505). Second system user can transfer his product from city B to city A without bearing any transportation expense and risk and can receive it physically from the warehouse. First system user can now receive his product, which is now in the city of B, physically, or continue to use it in the system for the swapping operations.

In FIG. 6, there are two system users in the financial institution with time and demand deposits. One of the users of the system does not need to use the money for a certain period of time, and the money is already in the checking account. The other keeps his money in time deposit, but also needs cash before maturity, in case he breaks the maturity, he would give up and lose the accumulated yields. First system user (60) deposits (601) his money (62) to the financial institution (61) on a term basis, and an electronic time deposit certificate (64) is issued (602) and transferred to the first system user's (60) wallet (63). Second system user (65) deposits (604) his money (66) at the financial institution (61) (there is no obligation to be the same financial institution), an electronic money certificate (68) is issued (605) and transferred to the second system user's (65) wallet (67). First system user (60) and the second system user (65) swap the time deposit certificate and the electronic money certificate (64:68) (603: 606). First system user (60) request (607) the money deposited to the financial institution (61) with the electronic money certificate (68) that transferred to his wallet (63) and withdraw (608) the money. By this method first system user met their cash needs without breaking down the time deposits. Second system user can wait for the time of the term deposit expire, as well as continue to use it in the system.

In FIG. 7, it is shown that although there are no swap conditions between two system users, lending of one system user's of his electronic certificate to the other system user that needs it, and, the return status of the borrowed electronic certificate.

First system user (70) delivers (701) the P asset (72) to the first secure storage point (71). First secure storage point (71) issues the electronic asset certificate (75) and transfer (702) to the wallet (74) of the system user (70). Second system user (76) delivers (706) the X product (78) to the second secure storage point (77). Second secure storage point (77) issues the electronic product certificate (792) and transfer (702) to the wallet (79) of the system user (76). First system user (70) transfer (703) the electronic asset certificate (75) in his wallet (74) to the second system user's (76) wallet (79) in return of a pledge applied on the electronic product certificate (792) in the second system user's (76) wallet (79) in pledge mechanism. Second system user (76) transfers (704) the electronic product certificate (75) in his wallet (79) to first secure storage point (71) and first secure storage point (71) delivers (705) asset P (72) to second system user (76). Second system user (76) delivers (709) the asset P (73) to the first secure storage point (71), the first secure storage point (71) issues and transfers (710) electronic asset certificate (791) to the second System user (76) wallet (79). Second system user (76) transfers (711) the electronic asset certificate (791) in his wallet (79) to the first system user (70) wallet (71), pledge mechanism (793) removes the pledge on the electronic product certificate (792) after completion of return process (711) and frees (713) the certificate possession rights in the second system user (76) wallet (79). If the return process (711) has not been made despite the set time, the pledge mechanism (793) transfers (712) the pledged electronic product certificate (792) to the first system user (70) wallet (71).

What is claimed is:

1. A method providing swapping assets simultaneously regardless of whether the assets are at a same secured storage point or a different secured storage point by agreed conditions and owners do not need to come together or use an intermediary institution, comprising the following step:
a. an electronic certification, wherein the electronic certification makes the assets, stored at a secured storage point, dematerialized for electronically transferring the assets to others,
b. a supply explaining intention and conditions to transfer an electronic certificate to the others,
c. a demand, describing the intention and conditions to acquire the electronic certificate when needed,
d. bargains, that provides the providing parties to agree on appropriate conditions,
e. a competition, that selects the selecting a most advantageous bid to a swap among more than one willing counterparty,
f. the swap providing a simultaneous electronic certificate exchange on the agreed conditions,
g. a swap of a pledge providing to transfer a pledged electronic certificate to a lender when there is a failure to return the electronic certificate borrowed for a certain period in return of the pledged electronic certificate in spite of the certain period is expired.

2. The method according to claim 1, wherein the electronic certification comprises: identification of electronic certificates issued by secure storage points included in a system, storing data of a bound asset and making dividable parts of the electronic certificate interchangeable with other electronic certificates in the system.

3. The method according to claim 1, wherein the supply explaining the intention and conditions to transfer the electronic certificate in a system user wallet to the others comprises the following process steps:
a. a private supply allowing only defined persons to accept a supply offer,
b. a public supply allowing to accept the supply to whoever interested in the supply offer,
c. a combined supply allowing an acceptance of different supply offer conditions to different people or groups.

4. The method according to claim 3, wherein private supply allowing only the defined persons to accept the supply offer comprises the supply offer configured to be made directly to the defined persons.

5. The method according to claim 3, wherein the public supply allowing to accept the supply to whoever interested in the supply offer comprises: providing to invite system users to accept the supply offer, and showing the supply offer in searches.

6. The method according to claim 3, wherein the combined supply allowing the acceptance of the different supply offer conditions to the different people or groups, comprises: providing private supply conditions to private system users with a private supply service while offering the different supply offer conditions to the others with a public supply service.

7. The method according to claim 1, wherein the demand describing the intention and conditions to acquire the electronic certificate needed comprises the following steps:
d. a search scanning a system limited with wallets of permitted system users to find information of required electronic certificates,
e. a private demand allowing anyone to propose to a system user holding a required electronic certificate and to accept a demand offer by a holder of the required electronic certificate,
f. a public demand allowing to accept the demand offer of a demander by any holders of the required electronic certificate.

8. The method according to claim 7, the search scanning the system limited with the wallets of the permitted system users to find the information of the required electronic certificates, comprises: finding the electronic certificates suitable with requirements of the permitted system users.

9. The method according to claim 7, wherein the private demand allowing anyone to propose to the system user holding the required electronic certificate and to accept the demand offer by the holder of the required electronic certificate comprises: ensuring a request is met by directly identified system users.

10. The method according to claim 7, wherein the public demand allowing accepting the demand offer of the demander by any holders of the required electronic certificate comprises: allowing the public demand can to be met by any system user and the demand offer appears in searches.

11. The method according to claim 1, wherein the bargains providing the parties to agree on the appropriate conditions comprises the following steps:
g. a bid enabling a system user to present different conditions, wherein conditions in the supply or the demand reach private persons or public,
h. a counter bid rejecting the bid received and providing a new counter offer,
i. a reconciliation enabling the parties to agree on the conditions for the swap.

12. The method according to claim 11, wherein the bid enabling the system user to present the different conditions, wherein in the different conditions the conditions in the supply or the demand reach the private persons or the public comprising providing the system user to inform acceptable conditions to a supplier or a demander instead of rejecting unacceptable offers.

13. The method according to claim 11, wherein the counter bid rejecting the bid received and providing the new counter offer comprises: providing favorable conditions to system users interested in supply offers or demand offers.

14. The method according to claim 11, wherein the reconciliation enabling the parties to agree on the conditions for the swap comprises: closing supply or demand offers records to bidding of the others upon the reconciliation of the parties, and blocking electronic certificates subject to the reconciliation for the swap.

15. The method according to claim 1, wherein the competition selecting the most advantageous bid to swap among the more than one willing counterparties comprises: the following steps:
j. an auction providing to permit more than one bids and/or an acceptance for a supplied electronic certificate until the certain period of time expired,
k. a reverse auction providing to permit the more than one bids and/or an acceptance for a demanded electronic certificate until the certain period of time expired,
l. a determination of a valid offer for the swap when a determined time is expired.

16. The method according to claim 15, wherein the auction providing to permit the more than one bids and/or the acceptance for the supplied electronic certificate until the certain period of time expired comprises: blocking for using in another swap and also withdrawing from the system, of the electronic certificate subjected to the auction by a party accepting conditions of the supply until the certain period of time expired, in case of offering an advantageous acceptance from other users by increasing an amount of an offer before the certain period of time expired, canceling and unblocking a previous acceptance and blocking the electronic certificate subjected to the auction for a recent acceptance.

17. The method according to claim 15, wherein the reverse auction providing to permit the more than one bids and/or the acceptance for the demanded electronic certificate until the certain period of time expired comprises: blocking for using in another swap and also withdrawing from the system, of the electronic certificate subjected to the reverse auction by a party accepting conditions of the demand until the certain period of time expired, in case of offering an advantageous acceptance from other users by decreasing an amount of an offer before the certain period of time expired, canceling and unblocking a previous acceptance and blocking the electronic certificate subjected to the reverse auction for a recent acceptance.

18. The method according to claim 15, wherein the determination of the valid offer for the swap when the determined time is expired comprises: closing to biddings of the others and strict blocking for the swap of supply records and/or demand records of electronic certificates taking into account a recent valid acceptance at a time when a term is completed.

19. The method according to claim 1, wherein the swap providing the simultaneous electronic certificate exchange on the agreed conditions comprises accepting supply or demand offers, providing reconciliation in the bargains, determining a recent valid offer in the competition, transferring electronic certificates subjected to a transaction in wallets of the parties simultaneously to a wallet of another party.

20. The method according to claim 1, wherein the swap of the pledge providing to transfer the pledged electronic certificate to the lender when the failure to return the electronic certificate borrowed for the certain period in return of the pledged electronic certificate in spite of the certain period is expired comprises: determining according to a recent situation after checking whether the electronic certificate borrowed has been returned within the certain period, transferring the electronic certificate subject to the pledge to a wallet of the lender, or removing the pledge on the electronic certificate freeing a borrower to use the electronic certificate.
